(19) United States
(12) Patent Application Publication
(10) Pub. No.: US 2015/0262225 A1
(43) Pub. Date: Sep. 17, 2015

(54) METHOD, APPARATUS, AND COMPUTER PROGRAM PRODUCT FOR CALCULATING PROFIT FOR A PROMOTION AND MARKETING SERVICE

(71) Applicant: GROUPON, INC., Chicago, IL (US)

(72) Inventors: Rene Haase, Chicago, IL (US); Aatif Sahib Din, Streamwood, IL (US); Pankaj Kumar, Bellevue, WA (US)

(73) Assignee: GROUPON, INC., Chicago, IL (US)

(21) Appl. No.: 14/212,511

(22) Filed: Mar. 14, 2014

(51) Int. Cl. G06Q 30/02

(52) U.S. Cl. CPC G06Q 30/0247

(57) ABSTRACT

A method, apparatus and computer program product are provided for calculating profits associated with a promotion or group of promotions offered by a promotion and marketing service. Profits may be calculated based on dynamically determined costs. The costs and profits may be averaged and/or summed for promotions associated with a category, subcategory and/or provider. A configurable view of the data included in the profit calculations may be provided to an internal user of a promotional system. Profit calculations may be used to identify certain types of promotions associated with high profits for a promotion and marketing service.

### BACKGROUND

Various embodiments of the invention are related to promotional systems, and particularly to a method and apparatus for calculating profit for a promotion and marketing service. Applicant has discovered problems with and related opportunities relating to internal users efficiently analyzing profit related to sales of promotions. Through applied effort, ingenuity, and innovation, Applicant has solved many of these identified problems by developing a solution that is embodied by the present invention, which is described in detail below.

### BRIEF SUMMARY

A method, apparatus, and computer program product are therefore provided for calculating profit for a promotion and marketing service based on a promotion and/or group of promotions.

A method is provided for calculating profit for a promotion and marketing service, the method comprising receiving an indication of a gross booking dollars, wherein the gross booking dollars is a hypothetical consumer cost of at least one promotion offered for sale by the promotion and marketing service, and wherein the at least one promotion is redeemable by the consumer at a provider, with a processor, dynamically determining one or more costs associated with the at least one promotion, wherein the one or more costs comprise at least a payment to the provider and a deal factory cost, calculating the profit associated with the at least one promotion and for the promotion and marketing service based on at least the dynamically determined one or more costs, and causing display of the profit associated with the at least one promotion and for the promotion and marketing service.

In some embodiments, the method further includes receiving cost assumptions from an internal user, wherein the profit for the promotion and marketing service is further based on at least the cost assumptions from the internal user. In some embodiments, the one or more costs are based on historical data associated with a promotion category. In some embodiments, the one or more costs are based on historical data associated with the provider.

In some embodiments, the method includes receiving an indication of a time period and a selected category, calculating respective profits for the promotion and marketing service for a plurality of subcategories associated with the selected category, and causing display of the respective profits for each of the plurality of subcategories.

In some embodiments, the method includes receiving an indication of a time period, and an indication of at least one of a selected category, selected subcategory, or geographic location, calculating respective profits for the promotion and marketing service during the time period and for a plurality of respective promotions associated with the at least one selected category, selected subcategory, or selected geographic location, and causing display of the respective profits for each of the plurality of promotions.

In some embodiments, the one or more costs comprise an estimated amount of net refunds per promotion based on a provider refund rate. In some embodiments, the one or more costs comprise an estimated cost of consumer points awarded to the consumer for purchasing the promotion.

In some embodiments, the method further includes providing an interface to the internal user, receiving a request via the interface to display a plurality of promotions and associated profits; ranking the plurality of promotions according to the request, and causing display of the plurality of promotions and associated profits in ranked order.

A computer program product is provided for calculating profit for a promotion and marketing service, the computer program product comprising at least one non-transitory computer-readable medium having computer-readable program instructions stored therein, the computer-readable program instructions comprising instructions, which when performed by an apparatus, are configured to cause the apparatus to perform at least receiving an indication of a gross booking dollars, wherein the gross booking dollars is a hypothetical consumer cost of at least one promotion offered for sale by the promotion and marketing service, and wherein the at least one promotion is redeemable by the consumer at a provider, dynamically determining one or more costs associated with the at least one promotion, wherein the one or more costs comprise at least a payment to the provider and a deal factory cost, calculating the profit associated with the at least one promotion and for the promotion and marketing service based on at least the dynamically determined one or more costs, and causing display of the profit associated with the at least one promotion and for the promotion and marketing service.

An apparatus for calculating profit for a promotion and marketing service is provided, the apparatus comprising processing circuitry configured to cause the apparatus to perform at least receiving an indication of a gross booking dollars, wherein the gross booking dollars is a hypothetical consumer cost of at least one promotion offered for sale by the promotion and marketing service, and wherein the at least one promotion is redeemable by the consumer at a provider, dynamically determining one or more costs associated with the at least one promotion, wherein the one or more costs comprise at least a payment to the provider and a deal factory cost, calculating the profit associated with the at least one promotion and for the promotion and marketing service based on at least the dynamically determined one or more costs, and causing display of the profit associated with the at least one promotion and for the promotion and marketing service.

### BRIEF DESCRIPTION OF THE SEVERAL VIEWS OF THE DRAWINGS

FIG. 1A and 1B are schematic representations of a promotional system according to example embodiments;

FIGS. 2-4 are example screen displays according to example embodiments;

FIG. 5 is a schematic block diagram of a promotional system according to example embodiments; and

FIGS. 6-7 are flowcharts illustrating operations for providing profit calculations, according to example embodiments.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the other computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

As used herein, the term “provider” may be used interchangeably with “merchant” and may include, but is not limited to, a business owner, consigner, shopkeeper, tradesperson, vender, operator, entrepreneur, agent, dealer, organization or the like that is in the business of a providing a good, service or experience to a consumer, facilitating the provision of a good, service or experience to a consumer and/or otherwise operating in the stream of commerce. One example provider may be a running company that sells attire for use by a person who runs or participates in athletic activities.

The promotion and marketing service (e.g., a service that provides promotion and/or marketing services on behalf of one or more providers that are offering one or more instruments that are redeemable for goods, services, experiences and/or the like by a consumer) may engage in business with a provider to offer a promotion. In some examples, the promotion and marketing service may enter into a “contract” (e.g., agreement defining the terms of the promotion and roles of the promotion and marketing services and provider with respect to the promotion) with the provider to offer a promotion, as described below.

As used herein, a “promotion” may be considered any type of offered, presented or otherwise indicated reward, discount, coupon, credit, deal, incentive, discount, media or the like that is indicative of a promotional value or the like that upon purchase or acceptance results in the issuance of an instrument that may be used toward at least a portion of the purchase of particular goods, services and/or experiences defined by the promotion. An “instrument” or “promotional instrument” may therefore be considered tender offered for sale by the promotion and marketing service on behalf of a provider. Consumers who purchase a promotional instrument may redeem a promotional instrument at the provider for goods or services.

As used herein, the term “service” may generally describe an action offered by a merchant in exchange for compensation. In this regard, a service may be a general descriptor of the action, and need not include information such as a duration, frequency, total number of times that the action will be performed, or even the compensation necessary for performance of the action. Using the aforementioned running company, an example service may be a private coaching session. In this example, the service itself need not include the duration of the coaching, the frequency of the lessons, the number of lessons that will be provided, or the cost of the lesson.

### Overview

In some examples, a promotion and marketing service may enter into a contract with a provider to offer promotions on behalf of a provider. In some examples, those promotions may then be provided to consumers in the form of impressions for review and potential purchase. In response, consumers may purchase a promotion in the form of an instrument from the promotion and marketing service to be redeemed at the provider in exchange for one or more goods, services or experiences. The promotion and marketing service may therefore receive revenue from the purchases made by consumers and split said revenue with the provider. As such, historically the promotion and marketing service may book or otherwise realize the difference between the revenue received from the consumers and the amount paid to providers as a margin for a particular promotion.

However, in some examples, the overhead or other expenses may not be uniformly split between each promotion. For example, some promotions may take additional time or expense to close, others may require additional advertising, whereas other merchants may require more internal support or the like. As such and in some examples, expenses associated with a purchased promotion, and/or general expenses for the promotion and marketing service (e.g., but not necessarily associated with a purchased promotion) may be difficult to determine, thereby causing profit to be difficult to calculate at a promotion, category, provider, or business, or level.

A method, apparatus, and computer program product are therefore provided to calculate profit for the promotion and marketing service at a promotion, category, provider, or business level. The method, apparatus, and computer program product may be provided via a promotional system. In some examples, calculating profit may include allocating general costs associated with operating the promotion and marketing service to a purchased promotion or group of promotions, to account for the general expenses of running a business, to account for business overhead, account for expenses in a geographical area and/or the like. As such, by dynamically calculating one or more costs for a promotion or group of promotions, the promotion and marketing service may calculate a profit for individual promotion(s).

In some examples, an internal user may use the promotional system to view calculated profits for a promotion category and/or subcategory. Indeed, the internal user may access the method, apparatus and computer program product via an application programming interface, via a request, via an interactive interface, or the like. The internal user may view calculated profits for a specific provider and/or marketing channel. In some embodiments, the internal user may provide a hypothetical gross booking dollars (e.g., revenue received from consumer purchases), among other inputs described herein, to view calculated profits based on dynamically calculated costs and the hypothetical gross booking dollars.

In some examples, an internal user may use the promotional system to view profits associated with actual gross booking dollars, such as by category and/or subcategory within a service hierarchy (e.g., taxonomy), and/or for a specified date range. In this regard, the calculated profit may be a sum or average of calculated profits for a promotion or group of promotions. In such cases, decisions related to particular types of promotions, particular categories or the like may be made. For example, if a particular channel, category or the like is seeing a higher profit margin when compared to another channel, category or the like, additional efforts may be focused to cut costs or adapt pricing for lower profit margins.

The internal user may therefore use the calculated profits to rank promotions by category or subcategory, provider, and/or the like to analyze data and/or discover what types of promotions are most profitable for the promotion and marketing service to offer. The profit calculations may therefore direct the promotion and marketing service to offer promotions determined to maximize profit for the promotion and marketing service, such as by targeting specific providers and/or promotion categories. Indeed, in some examples the profit calculations may be used to enable one or more widgets to bid on promotion and/or non-promotion content for display to a consumer.

### EXAMPLE EMBODIMENTS

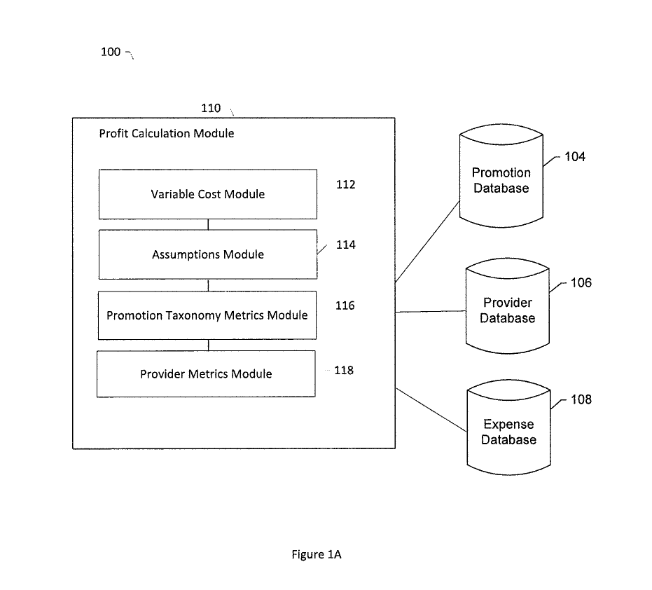

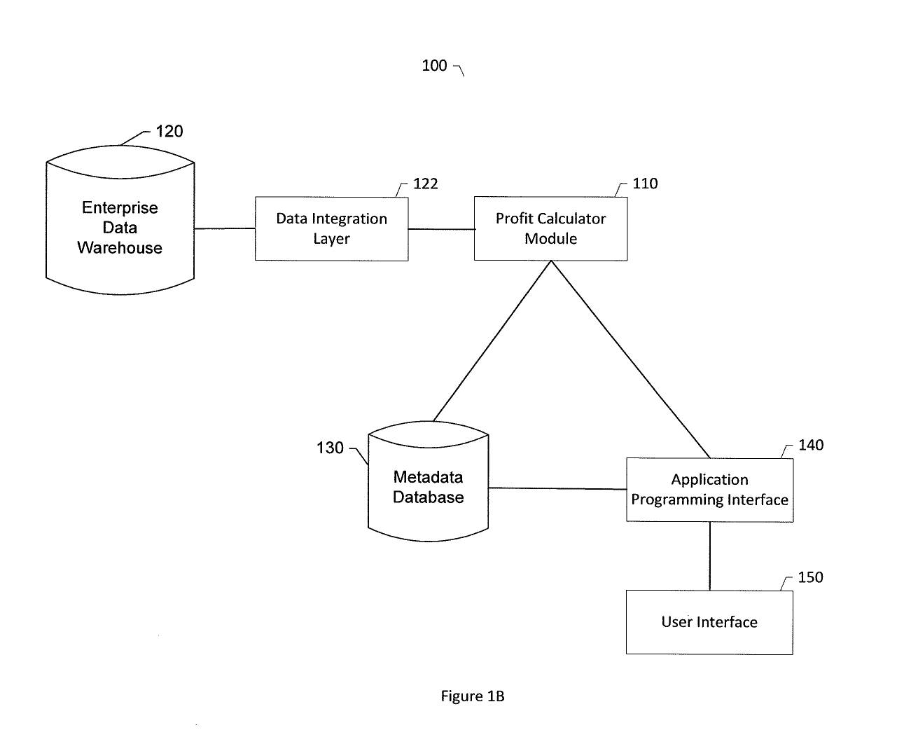

In some example embodiments, a profit calculation module is generated by a promotional system for use by a promotion and marketing service. By way of further example, FIG. 1A is a schematic representation of a promotional system according to an example embodiment.

In general, the promotional system 100 may include a promotion database 104 for providing promotion information, including revenue and costs associated with past and currently offered promotions. The provider database 106 may include provider details such as provider margins (e.g., percent of gross booking dollars payable to the provider), categories of products and/or services offered, and information related to promotions offered on behalf of the provider. The expense database 108 may include information regarding any expenses incurred by the promotion and marketing service, which may include actual costs incurred for offering a particular promotion and/or general expenses allocated amongst promotion(s).

The system 100 may further comprise any of a profit calculation module 110, variable cost module 112, assumptions module 114, promotion taxonomy metrics module 116, and/or provider metrics module 118.

In embodiments, the system 100 comprises a profit calculation module 110 for calculating profit for the promotion and marketing service based on information provided by modules 112, 114, 116, and/or 118. Variable cost module 112 may provide information relating to variable expenses, some of which may be dynamically calculated based on expenses associated with promotions, providers, and/or general expenses, such as respectively provided by promotion database 104, provider database 108, and/or expense database 108.

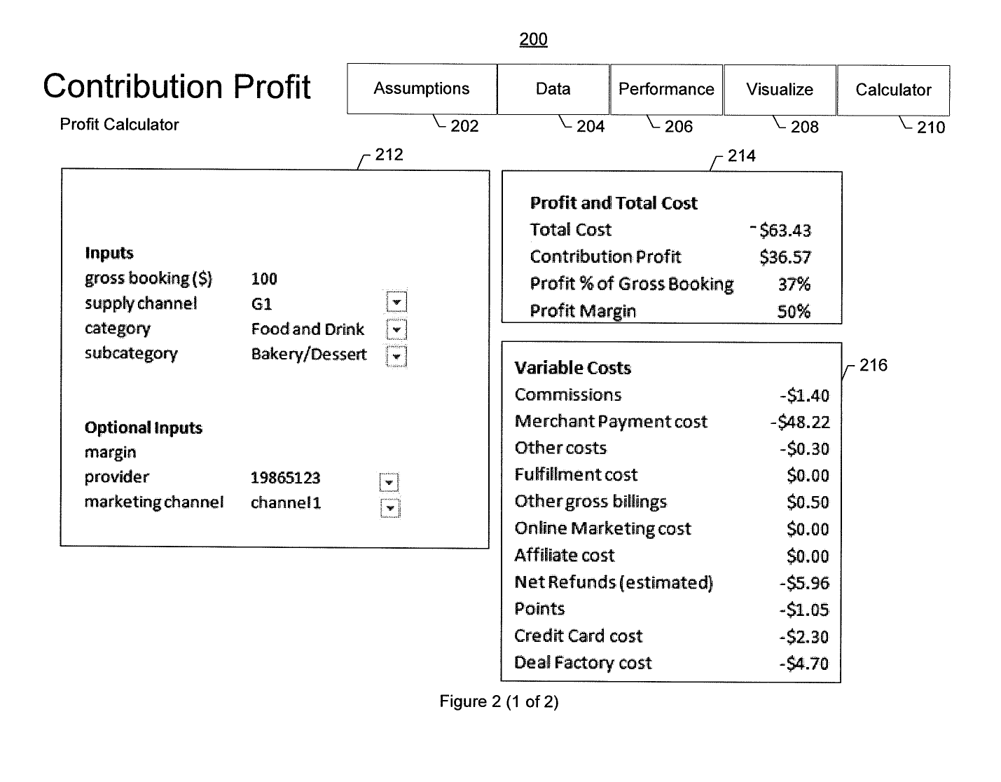

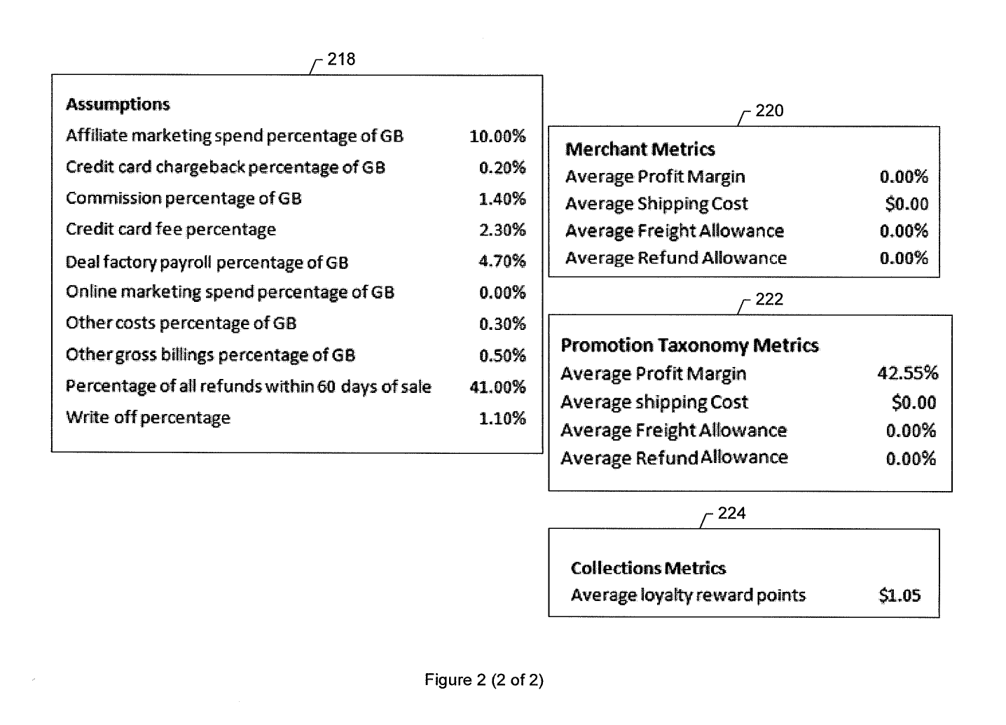

Assumptions module 114 may provide information relating to costs, and may therefore be in communication with variable cost module 112. The assumptions module 114 may be configured to receive internal user input to manually and/or temporarily override cost assumptions so that an internal user may view calculated profits based on hypothetical costs as described herein with respect to area 218 of FIG. 2. In some examples, hypothetical costs may include the projected cost for a sales person to pursue a particular provider or promotion. In some cases, particular providers may be very difficult to close, but also very important to a promotion and marketing service. As such, the potential decrease in profits may be acceptable. Whereas, in other examples, the additional sales costs may dissuade the promotion and marketing service from contacting certain providers.

In some examples, assumptions provided to the assumptions module 114 may be stored for subsequent use. For example, an internal user associated with a particular marketing channel may provide cost assumptions. The cost assumptions may be stored in such a manner that when another internal user identified as relating to the same marketing channel accesses the profit calculation module 110, the provided cost assumptions are preloaded into the assumptions module 114. As such, up to date cost assumptions (e.g., dynamically updating cost assumptions) may be efficiently and automatically maintained by the assumptions module 114. Such functionality may reduce the manual labor needed from the internal user each time the internal user accesses the profit calculate module 110.

Promotion taxonomy metrics module 116 may provide information relating to profit calculations based on promotion categories and/or subcategories, such as provided by the promotion database 104. For example, promotion taxonomy metrics may include average profit margins, average shipping cost, average freight allowance, and/or average refund allowance per category and/or subcategory. Promotion taxonomy metrics are described in more detail with respect to area 222 of FIG. 2 below. Such metrics may enable an internal user to analyze costs and profits with regards to a particular category and/or subcategory.

Provider metrics module 118 may provide information relating to profit calculations and costs based on providers, such as provided by the provider database 106. For example, provider (e.g., merchant) metrics may include average profit margin, average shipping cost, average freight allowance, and/or average refund allowance for a particular provider. Provider metrics, or merchant metrics, are described in more detail with respect to area 220 of FIG. 2 below. Provider metrics may enable an internal user to analyze costs and profits with regards to a specific provider. As such, an internal user may target a provider known to produce high profits for the promotion and marketing service in future sales calls and/or proposals.

In some examples, the promotion and marketing service may determine or otherwise learn, such as through a learning algorithm, certain profit calculations that are usable to develop future cost metrics. For example, certain assumptions may be made about all restaurants or businesses in a local area. These predictions may allow for certain predictions related to future promotions, certain geographical areas, certain providers or the like. As such, once certain assumptions and/or estimates are developed, such estimates may be used to populate or otherwise provide guidance when operating or otherwise interacting with the profit calculator module 112.

FIG. 1B is an alternative or additional schematic representation of system 100 according to an example embodiment. The profit calculator module 110 may retrieve data from an enterprise data warehouse (EDW) 120, such as via a data integration layer 222. The EDW 120 may comprise vast amounts of data, which may be updated and/or provided by various sources. In some examples, the EDW 120 may comprise any of the promotion database 104, the provider database 106, and/or the expense database 108. The EDW 120 may be configured to maintain extensive data collected by various systems and subsystems relating to the promotion and marketing service.

The data integration layer 122 may be configured, in some examples, to serve as an interface between the profit calculator module 110 and the EDW 120. In this regard, the data integration layer 122 may transform and/or stage data requested by the profit calculator module 110. In some examples the data integration layer 122 may organize the data for efficient access by the profit calculator module 110.

The profit calculator module 110 may process the data, such as with any of the modules 112, 114, 116, and/or 118 (as shown in FIG. 1), according to example embodiments described herein. According to some embodiments described herein, the profit calculator module 110 may perform various cost and profit calculations. Resulting data may be stored as metadata in a metadata database 130, allowing for efficient retrieval of the data by the profit calculator module 110 (e.g., such as for subsequent calculations) and/or an application programming interface (API) 140. The API 140 may be configured to interface with various services and/or systems of the promotion system 100. For example, the API 140 may be configured to provide profit calculations, such as from the profit calculator module 110 and/or metadata database 130, to a user interface 150. The user interface 150 may in turn produce a user interface for an internal user, such as the example displays provided and described herein with respect to FIGS. 2-4 and 4.

FIGS. 2-4 are example displays provided by the promotional system 100 according to example embodiments. FIG. 2 illustrates a display 200 for providing profit calculations to an internal user. Near the top of the display 200, tabs 202, 204, 206, 208, and 210 are provided for accessing variations of display 200. The assumptions tab 202 may be provided by the assumptions module 114 and may be accessed by an internal user for overriding costs (e.g., the costs described with respect to area 218 of display 200, below.

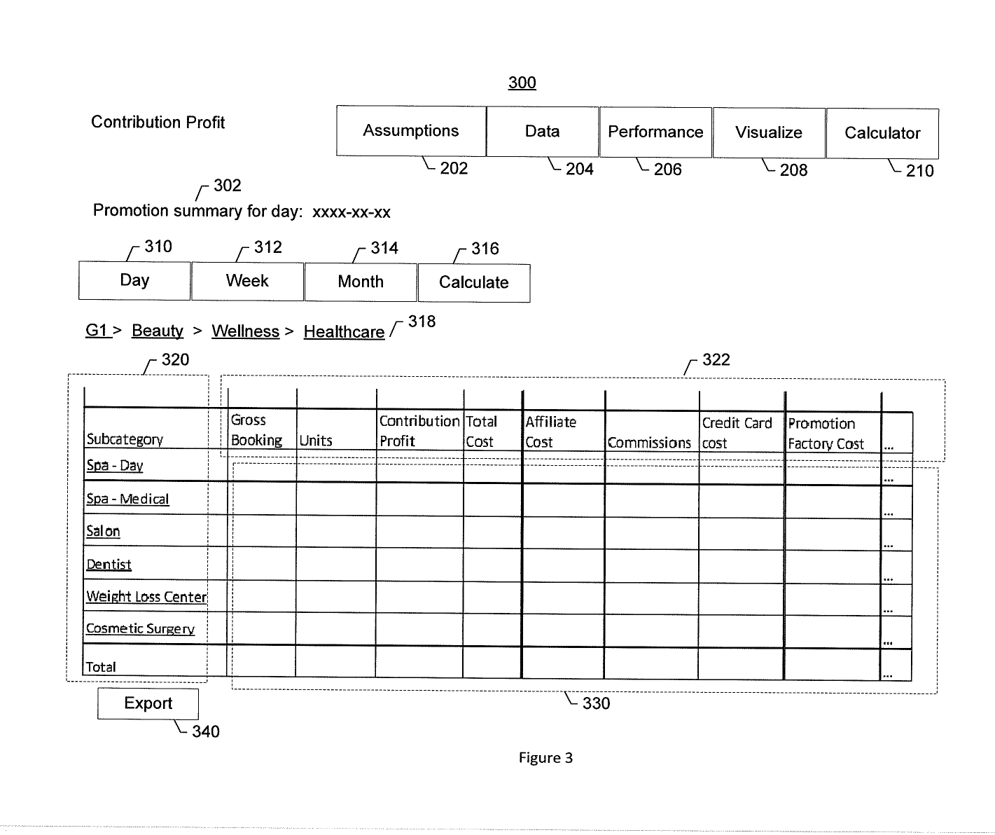

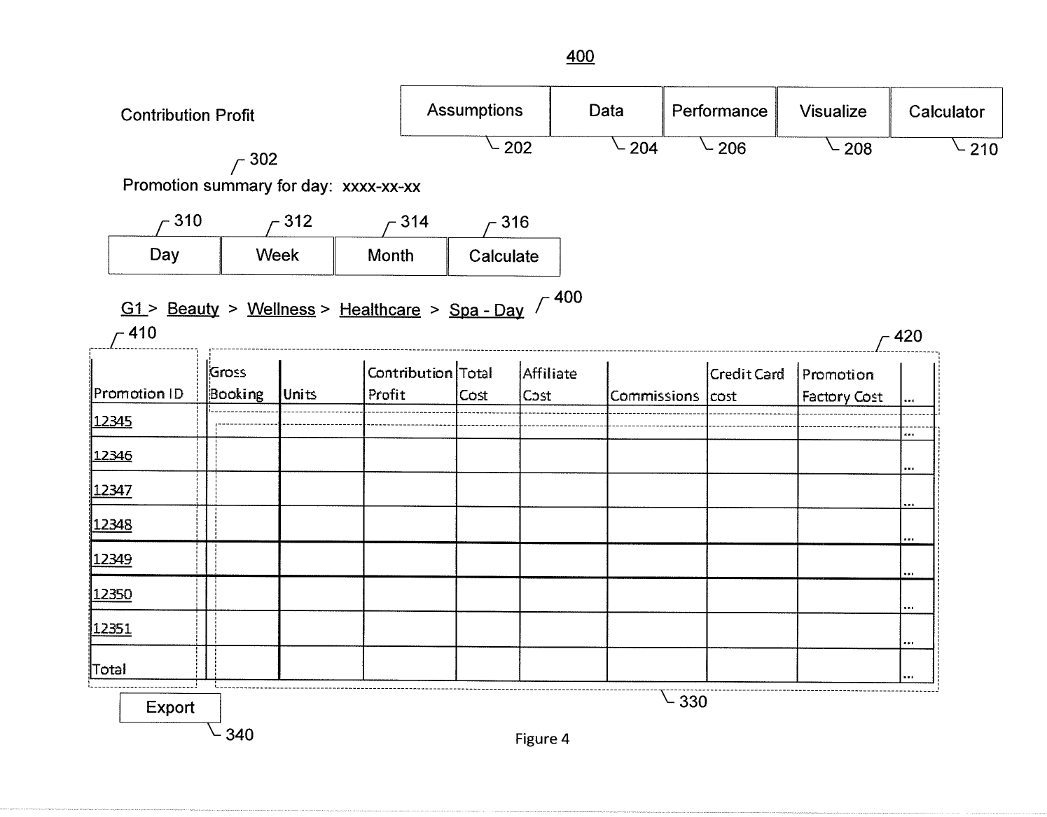

The data tab 204 may provide another view of the profit calculations, such as those illustrated in and described with respect to FIGS. 3 and 4 below. The performance tab 206 provides a view of a top 10 and bottom 10 promotions based on calculated profit in a specified time period. Any of the data discussed herein, such as with respect to displays 200, 300 and/or 300, may additionally be provided on the performance tab. The display provided via the performance tab 204 may provide consolidated, long term profit and/or return information relative to the more detailed information provided by the display of the calculator tab 210, described in more detail below.

The visualize tab 208 may provide graphical representations of the data provided by the data tab 204. An internal user may use the visualize tab 208, in some examples, to view line graphs, and/or the like to efficiently gauge general trends over time relating to cost and profit for the promotion and marketing system.

The calculator tab 210 may provide an internal user with the ability to provide inputs, such as those described below with respect to area 212, and view calculated profits based on the inputs. The display 200 as illustrated in FIG. 2 provides an example of information that may be displayed in response to selection of the calculator tab 210.

Area 212 displays input fields or parameters that may be provided and/or edited by an internal user. Gross booking dollars, or revenue received from a consumer for the purchase of a promotion, may be provided by the internal user. Gross booking dollars may be alternatively or additionally referred to as gross booking amount, and may be a hypothetical amount, or an amount commonly paid by a consumer for a promotional instrument. A supply channel, such as G1, may be selected from a list of available supply channels, which indicates a channel by which a promotion is provided. Some example includes available services (i.e., G1 or daily promotions), recurring services, goods, experiences or getaways.

A category and/or subcategory may be selected. Options for a category may be limited based on a selected supply channel, while options provided for a subcategory may be limited based on a selected subcategory. Once a category and/or subcategory is selected certain assumptions for the particular category and/or subcategory may be populated into the input fields or parameters. Indeed, category and/or subcategory may be used to populate some or all of the input fields or parameters.

Any of the data displayed with respect to display 200 may be dependent on any of the supply chancel, category, and/or subcategory. Assumptions used to calculate profit may be dependent on supply channel, category, and/or subcategory. Historical data may be based on supply channel category, and/or subcategory. As an example, for a same booking amount, a supply channel of G1 may result in a different profit calculation than a supply channel of getaways. Similarly, filtering by sub category and/or category may result in different profit calculations.

In some embodiments, the internal user may enter a provider margin (e.g., the percentage of the gross booking dollars, or revenue, payable to the provider), and provider (e.g., unique identifier of a provider or name of a provider from a list of available providers), and/or a marketing channel by which a promotion is offered to a consumer. For example, a marketing channel may include Search Engine Marketing (SEM), Display (e.g., provided via an interface generated by the system 100, and/or Affiliates (e.g., provided via an interface generated by a third party). Costs to advertise promotions through these different marketing channels may vary. Therefore, depending upon a selected marketing channel profit calculations may also vary. As an example, SEM marketing for a $10 booking may cost $1, while Display marketing may cost $1 per $10 booking

In some embodiments, entry of a provider margin may result in an override of the provided provider margin (e.g., average profit margin) in area 220 and described below. In some examples, in an instance in which a provider and/or marketing channel is selected, any of the information provided on display 200 may update accordingly. For example, a particular provider and/marketing channel may be associated with specific assumptions, as provided by the assumptions module 114, and display in area 218, described herein.

Alternatively or additionally, in some examples certain costs may be noted as a fixed cost for a promotion whereas other costs may be variable costs that may change over the life of the promotion. Certain fixed costs may be updated in real time or near real time as certain fixed costs (e.g., current costs of buildings, employees, server farms, etc.) change. Variable costs may also be constantly updated. In some examples, variable costs may be tracked by tracking any interaction with the promotion by representatives of the promotion and marketing service.

In area 214, the promotion calculator module 110 may provide calculated cost and profit information based on the inputs provided in area 212 and the dynamically calculated costs as described with respect to areas 216 and 218 below. The total cost may be calculated by the variable cost module 112 based on variable and/or estimated costs described with respect to area 216. In some embodiments, the total cost may be a sum of the costs provided in area 216, for example. The total cost may be a dollar amount of costs incurred by the promotion and marketing service per gross booking dollars in promotions (e.g., as provided by an internal user), the promotions identified being based on any of the supply channel, category, subcategory, provider, and/or marketing channel indicated by the internal user.

Alternatively or additionally, costs may be dynamically updated during the period before, during and after a promotion is offered. For example, in some embodiments, certain cost assumptions may be updated during the lifecycle of a promotion. In some examples, certain refund rates may be assumed prior to a promotion and may be updated and refunds are issued. In further examples, further costs may be updated during the course of the promotion related to cost of assisting consumers, costs of consulting with the provider and/or the like.

The contribution profit, or profit, may be a profit in dollars, made by the promotion and marketing service per gross booking dollars based on the provided inputs in area 212. In some examples, the profit may be an actual or estimated profit for a particular group or type of promotion, the group of promotions being defined by any of a supply channel, category, subcategory, provider, and/or marketing channel, as may be provided by an internal user in area 212.

Also included in area 214 may be the calculated profit percentage of gross booking, which may be calculated based on profit in dollars÷gross booking. A profit margin may also be calculated as profit÷revenue, and may be displayed as a percentage profit margin.

Area 216 provides a listing of variable costs, in dollar amounts, that may be incurred by the promotion and marketing service per gross booking dollars. The variable costs may be provided, calculated, and/or estimated by the variable cost module 112, and may be dependent on any of the inputs provided in area 212. The costs may be based on data associated with any number of promotions in the promotion database 104, which may be limited based on the inputs provided in area 212, such as by supply channel, category, subcategory, provider, and/or marketing channel.

Commissions may be calculated as an average sales commission paid to a sales resource(s) responsible for contracting with the provider on behalf of the promotion and marketing service, per gross booking dollars. In some cases, commissions may be dynamically linked to particular sales people so as to continue to update accurately the actual commission paid to the particular sales provider. In some embodiments, may vary across promotion taxonomies and/or providers. For example, a sales resource responsible for entering into a contract with a provider having high brand name recognition and/or widespread retail presence may be awarded a higher commission than a sales resource accredited with contracting with a diner in a small town. As another example, promotions associated with a travel category, known to have higher gross booking amounts per promotion instrument, may provide higher commissions than those promotions for restaurants and/or the like. As such, the commission amount, in some embodiments, may vary based on the input provided in area 212.

Merchant payment cost, or provider payment cost, may be the amount paid by the promotion and marketing service to a provider(s) per gross booking dollars. The provider payment cost may be dependent on a provider margin input in area 212. In such examples in which the provider margin is provided, the provider payment cost may be calculated based on gross booking dollars * provider margin (%). In instances in which a provider margin is not provided as an input, the variable cost module 112 may calculate an average provider margin paid based on current promotions and/or contracts with providers, such as provided by the promotion database 104 and/or provider database 106. Similar to the cost of commissions, merchant payments may vary based on a promotion taxonomy or provider. Providers having a high brand name recognition may demand higher margins than providers wanting to increase their clientele. Promotions belonging to popular categories and promotions relating to specialized categories may similarly have different corresponding merchant payment costs, for example.

Other costs may include email costs, promotional activity costs, and/or the like, and may be provided by the expense database 108. Email costs may include expenses incurred in email marketing, such as charged by a third party service or incurred based in-house web marketing. Other marketing costs and other costs associated with revenue may also be included.

Fulfillment cost may include costs associated with delivery of a redeemable promotional instrument to a consumer. In some instances, as those in which a redeemable promotional instrument may be automatically generated by system 100 and printed by the consumer, the fulfillment cost may be zero. In some embodiments, such as those in which a purchased promotion results in delivery of a good or product, the fulfillment cost may be related to fulfilling an associated order to be delivered from the provider, third party vendor and/or warehouse, and/or the like.

Other gross billings include costs incurred due to other billings associated with a promotion and/or group of promotions, such as revenue generated from billings other than sales or promotions. Other gross billings may be calculated based on data provided by the expense database 108, for example. Other gross billing may represent revenue generated by the promotion and marketing service by anything other than the sale of promotional instruments. For example, the promotion and marketing service may liquidate property and/or goods, and generate income by selling advertising to third parties. As another example, tax related benefits (revenue) may be considered, such as revenue generated for operating a business in multiple countries. Other gross billings is calculated based on historical numbers and/or assumptions (described in further detail below with respect to area 218). For example, an assumption may be provided as a percentage other gross billing of gross bookings. Other gross billings in dollars may therefore be calculated as the assumed percentage other gross billings of gross bookings * gross booking dollars.

Online marketing costs may include any general costs associated with the marketing of the promotional system 100, such as maintaining and/or hosting a website provided by the promotional system. Online marketing costs may include advertising on third party websites that lead consumers to a website of the promotion and marketing service by which the consumer may purchase a promotion. Online marketing costs may therefore represent an average expense per gross booking dollars used in online marketing, and may be calculated by the variable cost module 112 based on data received from the expense database 108.

In some examples, the online marketing costs may be effectively tracked in real time or near real time based on the current cost for each customer that accesses the promotion and marketing service via the advertising link. For example, one or more marketing services may be tracked such that the cost for one or more adwords, advertisements, pay-per-click instances, or the like are tracked.

Affiliate costs may include expenses related to third parties and/or business entities partnering with the promotion and marketing service to offer the promotion, and may also be provided by the expense database 108.

Net refunds include an estimated or calculated average refund amount per gross booking dollars. Refunds may be paid back to a consumer who originally purchased a promotion but later requested a refund. In some instances refunds may be granted because a provider is no longer in business or no longer offering a particular service. In some embodiments, refunds may be granted with no reason other than consumer request. The net refund amount may be estimated based on past refund amounts for a particular type of promotion or group of promotions, such as those associated with a certain provider. Real-time updates to refunds may be made to the EDW 120, expense database 108, and/or the like. Such updates may therefore be reflected by the profit calculation module 110 without any manual updates.

Points may include costs associated with reward points issued to a consumer for the purchase of a promotion. The promotion and marketing service may issue reward points that may be redeemed in the purchase of subsequent promotion purchases. The reward points may therefore be associated with a calculated dollar amount or cost to the promotion and marketing service based on a future discount awarded to a consumer and at the expense of the promotion and marketing service. In some examples, a business unit of the promotion and marketing service may offer a special promotion with significant expense to the promotion and marketing service in the terms of cost in points. In an instance such data is provided to the system 100, the profit calculation module 110 may automatically reflect in its calculations such changes to a cost in points.

Credit card costs may include a fee paid to and/or retained by a credit card company based on the purchasing consumer's payment method. The credit card fee may be deducted prior to payment from the credit card company to the promotion and marketing service. The EDW 120 and/or expense database 108 may therefore be configured to automatically track credit card fees charged by credit card companies. As a relatively small cost that may otherwise be overlooked, promotional system 101 may therefore provide for seamless updates to the cost information, and therefore downstream profit calculations without having to manually monitor the fees charged.

Deal factory cost may include expenses incurred by the promotion and marketing service for offering incentives to consumers to entice consumers to purchase promotions from the promotion and marketing service. For example, in response to a lapse of time between purchases by a particular consumer(s), the promotion and marketing service may offer a free and/or discounted promotion to entice consumers to continue purchasing promotions. In some examples, promotions may be offered for providers having high brand recognition and popularity to entice consumers to purchase a promotion. To offer the promotion, the promotion and marketing service may offer a higher than average provider margin to the provider for agreeing to offer such a promotion. In some examples, this may result in a high cost to the promotion and marketing service but with the expectation of the promotion generating additional sales in promotions based on an increase of web traffic to a website of the promotion and marketing service. The deal factory cost may therefore include average amounts of expenses associated with providing such incentives.

In some examples, deal factory cost may include general expenses associated with operating the promotion and marketing service. For example, payroll and/or benefits paid to employees of the promotion and marketing service and/or expense associated with maintaining a physical office may be included in the deal factory cost. The promotion and marketing service may incur payroll expenses for a sales team, editorial staff (e.g., authors of promotion descriptions), city planning (e.g., staff that ensure a smooth promotion offering and manage a promotion portfolio), customer service employees (e.g., staff that manage refunds and aim to improve customer experience), and/or employees who perform research providers and provider services, for example. The deal factory cost may additionally or alternatively include payroll expenses relating to employees in operations, and/or revenue and category management, for example. This expense information may be obtained from the expense database 108, and calculated as an average deal factory cost by variable cost module 112.

Assumptions provided in area 218 may include percentages of costs and/or expenses incurred by the promotion and marketing service. The assumptions may be overridden by manual entry by an internal user, such as provided via display provided in response to selection of the assumptions tab 202. A display may be provided by the assumptions module 114 to enable user entry of the assumptions (not shown). The currently entered or considered assumptions may be maintained by the assumptions module 114, and provided in area 218 of display 200. The assumptions may directly impact the variable costs calculated by the variable cost module 112.

For example, affiliate marketing spend percentage of gross bookings may include expenses related to third parties and/or business entities partnering with the promotion and marketing service to offer the promotion. Credit card chargeback percentage of gross bookings represents the percentage amount of chargebacks from credit card payments compared to gross booking dollars. Chargebacks may include reversal of payments from credit card companies, such as in an instance a consumer's payment method is rejected, such as for exceeding a credit limit on a credit card.

Commission percentage of gross bookings may indicate a percentage of gross bookings payable to a sales resource for compensation. In some examples, the commission percentage of gross bookings may vary across promotion taxonomies and/or providers. For example, a sales resource responsible for entering into a contract with a provider having high-brand recognition and/or widespread retail presence may be awarded a higher commission than a sales resource accredited with contracting with a diner in a small town. As another example, promotions associated with a travel category, known to have higher gross booking amounts per promotion instrument, may provide higher commissions than those promotions for restaurants and/or the like. As such, the commission percentage of gross bookings may, in some embodiments, vary based on the input provided in area 212.

Credit card fee percentage may indicate the percentage of gross booking dollars retained by or paid to credit card companies used by a consumer for purchasing a promotion(s). The EDW 120 and/or expense database 108 may therefore be configured to automatically track credit card fees charged by credit card companies. As a relatively small cost that may otherwise be overlooked, promotional system 101 may therefore provide for seamless updates to the cost information, and therefore downstream profit calculations without having to manually monitor the fees charged.

Deal factory payroll percentage of gross bookings may indicate a percentage of gross bookings allocated for payroll and/or staff expenses. The deal factory payroll percentage may be a calculation based on any personnel expenses incurred by the promotion and marketing service, such as salaries and hourly wages to any employees, staff, and/or the like associated with the promotion and marketing service. In some examples, real-time updates to the EDW 120 with information relating to payroll may affect the deal factory payroll percentage of gross bookings. For example, in an instance in which the promotion and marketing service expands to open a new sales office, payroll payments may drastically increase, thereby temporarily diminishing profits until the new sales office generates proportionate sales to offset the associated expenses.

Online marketing spend percentage of gross bookings, other costs percentage of gross booking, and/or other gross billings percentage of gross billings, may be indicated as a percentage of gross booking dollars in accordance with their respective costs, described above. Online spend percentage of gross bookings may include advertising on third party websites that lead consumers to a website of the promotion and marketing service by which the consumer may purchase a promotion. Online marketing costs may therefore represent percentage gross booking dollars used in online marketing, and may be calculated by the variable cost module 112 based on data received from the expense database 108.

In some examples, the online marketing spend percentage may be effectively updated in real time or near real time based on the current cost for each customer that accesses the promotion and marketing service via the advertising link. For example, one or more marketing services may be tracked such that the cost for one or more adwords, advertisements, pay-per-click instances, or the like are tracked.

Percentage of all refunds within 60 days of sale may indicate the percentage of all refunds that are issued and/or requested within the first 60 days of a sale. This percentage may directly impact the estimated net refunds calculated by the variable cost module 112. As refunds are processed by the promotional system 100, corresponding databases may be updated. The profit calculation module 110 may therefore reflect the most recent data available with respect to refunds. In some examples, some certain providers and/or promotion categories may be prone to high or low refunds rates, relative to other groups of promotions.

Write off percentage may indicate a percentage of average write off dollars per gross booking dollars. In some instances in which consumers request refunds, the promotion and marketing service may receive a portion of refunds reimbursed from providers. In some instances, the promotion and marketing service may not receive a refund, and the write off percentage accounts for this portion not reimbursed.

Area 220 may include merchant metrics, which may indicate average metrics (e.g., costs) for promotions associated with a particular merchant or provider, such as selected in area 212. The merchant or provider metrics may be provided by the provider metrics module 118. For example, the average profit margin for the promotion and marketing service based on promotions offered on behalf of a selected provider may be displayed. The average shipping cost of goods shipped (e.g., per promotional instrument) to fulfil promotions offered in association with the provider may also be provided, as calculated by the variable cost module 112. The average freight allowance may be displayed and may include the average percentage of the gross booking dollars designated for shipping goods for the particular provider. Freight allowance may be an amount that is included in the price of the goods for freight charges. Freight allowance may be considered in the computation of provider payment costs. For example, the following formula may be used: provider payments=−(gross booking dollars*(1-margin)*(1-refund allowance−freight allowance). In instances in which a user does not supply a freight allowance for a promotion, historical averages of freight allowances may be considered, such as provided by expense database 108. Additionally, an average refund allowance may be displayed and may include an average percent of refunds per gross booking dollars, for the particular provider.

Area 222 may include promotion taxonomy metrics, which may indicate average metrics (e.g., costs) for promotions associated with a particular category, subcategory, and/or the like. The promotion taxonomy metrics module 116 may provide the promotion taxonomy metrics. For example, the average metrics for promotions belonging to the same category and subcategory, “food and drink”, and “bakery/dessert,” respectively indicated in area 212, may be provided. As such, the average profit margin in area 222 may indicate the average profit margin for the promotion and marketing service for promotions offered in the particular category and/or subcategory. Likewise, the average shipping cost may indicate the average shipping cost of goods shipped in association with promotions of a selected category and/or subcategory. Average freight allowance may be displayed and may include the average percentage of the gross booking dollars designated for shipping of goods associated with promotions in the selected category and/or subcategory. Additionally, an average refund allowance may be displayed and may include an average percent of refunds per gross booking dollars, in promotions belonging to the indicated category and/or subcategory.

Collections metrics display in area 224 may include average loyalty reward points, which may include a cost in points based on average loyalty points used to purchase a promotion. The average loyalty reward points may be calculated based on historical data. In some examples, points may be valued at $1 per point. In some embodiments, another ratio of point to dollar value may be applied.

In some embodiments, the promotion and marketing service may issue reward points that may be redeemed in the purchase of subsequent promotion purchases. The loyalty reward points may therefore be associated with a calculated dollar amount or cost to the promotion and marketing service based on a future discount awarded to a consumer and at the expense of the promotion and marketing service. In some examples, a business unit of the promotion and marketing service may offer a special promotion with significant expense to the promotion and marketing service in the terms of cost in points. In an instance such data is provided to the system 100, the profit calculation module 110 may automatically reflect in its calculations such changes to a cost in points.

FIG. 3 illustrates an example display 300 for providing promotion metrics and corresponding costs and profit. An internal user may select any of the respective ‘day,’ week,' and/or ‘month’ filters 310, 312 and/or 314. A descriptor 302 may update according to indicate a time period for which data will be displayed. The time periods may relate to time periods in which promotions were offered, for example. Upon selection of the ‘calculate’ button 316, data displayed in area 330 may be provided based on the time period selected and as described below.

Filters 318 may allow an internal user to filter by promotion taxonomy (e.g., category and/or subcategory). In some embodiments, an internal user may use filter 318 to select a provider. In the example display 300, a category “healthcare” is selected, and column 320 updates with corresponding subcategories to the parent category of “healthcare.” Row 322 may provide column headers for any metrics provided on display 200. Area 330 may reflect cumulative total amounts (not shown) of a particular metric (as indicated by respective column header in row 322) for groups of promotions belonging to respective subcategories indicated in column 320.

‘Export’ button 340 may allow an internal user to export the displayed data to a file such as a comma separated value (CSV) and/or the like.

An internal user may additionally or alternatively sort and/or view ranked promotions and/or groups of promotions by selecting column headers (not shown). As such, the profit calculation module 110 may rank promotion(s) based on profits. The interface provided by display 300 may allow an internal user to efficiently analyze costs and profits relating to promotions of specific categories, subcategories and/or providers. Internal users may therefore identify which types of promotions are the most profitable for the promotion and marketing service. More promotions of that type may therefore be offered in the future, further increasing profitably of the promotion and marketing service.

FIG. 4 illustrated a display 400 which is a variation of display 300, modified based on internal user selections. Display 400 may be provided in response to selection of the subcategory “Spa-Day” on display 300. Filters 400 may update accordingly to indicate the displayed data relates only to the subcategory “Spa-Day.” Column 410 may update to show individual promotion identifiers. In this example, each promotion offered during the given time frame and in the subcategory “Spa-Day” is displayed. The data updated in 330 may therefore represent cumulative totals for the respective promotion as indicated by the promotion identifier.

While displays 300 and 400 are provided as examples of how an internal user may utilize an interface provided by the profit calculator module, many other variations may also be provided.

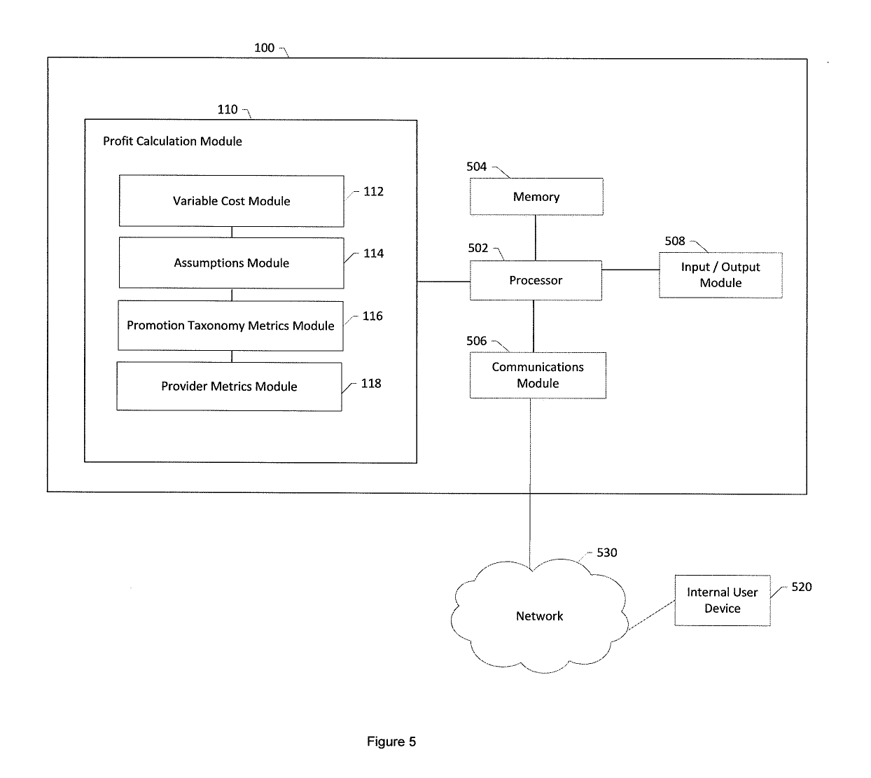

Having now described example displays provided by the profit calculator module 110, FIG. 5 provides an implementation of promotional system 100 according to an example embodiment.

In accordance with some example embodiments, promotional system 100 may include various means, such as one or more processors 502, memories 504, communications modules 506, and/or input/output modules 508. A promotional system 100 may further include profit calculator module 110, variable cost module 112, assumptions module 114, promoting taxonomy metrics module 116, and/or provider metrics module 118, among other things (not shown). As referred to herein, the term “module” includes hardware, software and/or firmware configured to perform one or more particular functions. In this regard, promotional system 100 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 504) that is executable by a suitably configured processing device (e.g., processor 502), or some combination thereof.

Processor 502 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 5 as a single processor, in some embodiments, processor 502 comprises a plurality of processors. The plurality of processors may be embodied on a single computing device or may be distributed across a plurality of computing devices collectively configured to function as promotional system 100. The plurality of processors may be in operative communication with each other and may be collectively configured to perform one or more functionalities of promotional system 100 as described herein. In an example embodiment, processor 502 is configured to execute instructions stored in memory 504 or otherwise accessible to processor 502. These instructions, when executed by processor 502, may cause promotional system 100 to perform one or more of the functionalities of promotional system 100 as described herein.

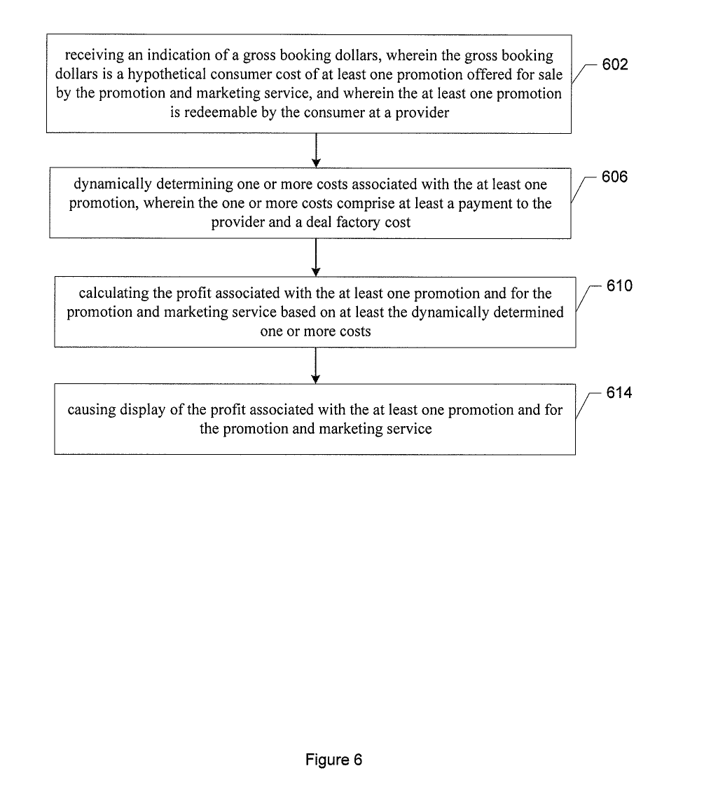

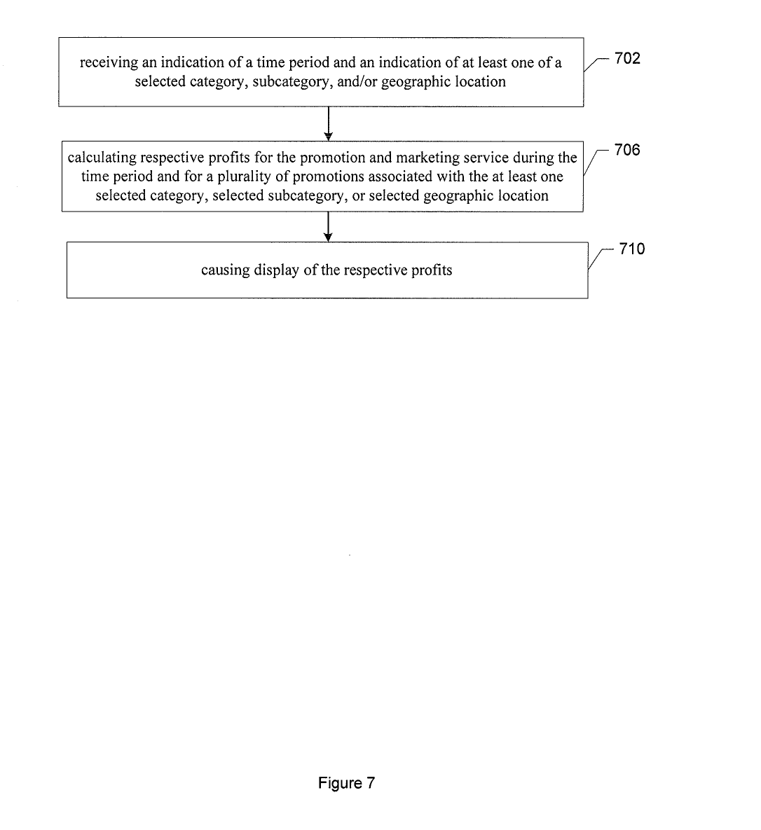

Whether configured by hardware, firmware/software methods, or by a combination thereof, processor 502 may comprise an entity capable of performing operations according to embodiments of the present invention while configured accordingly. Thus, for example, when processor 502 is embodied as an ASIC, FPGA or the like, processor 502 may comprise specifically configured hardware for conducting one or more operations described herein. As another example, when processor 502 is embodied as an executor of instructions, such as may be stored in memory 504, the instructions may specifically configure processor 502 to perform one or more operations described herein, such as those discussed in connection with FIGS. 6 and 7 below.

Memory 504 may comprise, for example, volatile memory, non-volatile memory, or some combination thereof. Although illustrated in FIG. 5 as a single memory, memory 504 may comprise a plurality of memory components. The plurality of memory components may be embodied on a single computing device or distributed across a plurality of computing devices. In various embodiments, memory 504 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In some embodiments, memory 504 may comprise a suitable network database (e.g., promotion database 104, provider database 106 expense database 108, EDW 120, and/or metadata database 130) configured to store information relating to promotions, providers, expenses and/or the like, as described herein. Additionally or alternatively memory 504 may be configured to store such data as well as various applications, instructions, or the like for enabling promotional system 100 to carry out various functions in accordance with example embodiments of the present invention. For example, in at least some embodiments, memory 504 is configured to buffer input data for processing by processor 502. Additionally or alternatively, memory 504 may be configured to store program instructions for execution by processor 502. Memory 504 may store information in the form of static and/or dynamic information. This stored information may be stored and/or used by promotional system 100 during the course of performing its functionalities.

Communications module 506 may be embodied as any device or means embodied in circuitry, hardware, a computer program product comprising computer readable program instructions stored on a computer readable medium (e.g., memory 504) and executed by a processing device (e.g., processor 502), or a combination thereof that is configured to receive and/or transmit data from/to another device, such as, for example, a second promotional system 100 and/or the like. In some embodiments, communications module 506 (like other components discussed herein) can be at least partially embodied as or otherwise controlled by processor 502. In this regard, communications module 506 may be in communication with processor 502, such as via a bus. Communications module 506 may include, for example, an antenna, a transmitter, a receiver, a transceiver, network interface card and/or supporting hardware and/or firmware/software for enabling communications with another computing device. Communications module 506 may be configured to receive and/or transmit any data that may be stored by memory 504 using any protocol that may be used for communications between computing devices, such as between the promotional system 100 and a sales resource device 130. Communications module 506 may additionally or alternatively be in communication with the memory 504, input/output module 508 and/or any other component of promotional system 100, such as via a bus.

Input/output module 508 may be in communication with processor 502 to receive an indication of a user input and/or to provide an audible, visual, mechanical, or other output to a user (e.g., provider and/or consumer). As such, input/output module 508 may include support, for example, for a keyboard, a mouse, a joystick, a display, a touch screen display, a microphone, a speaker, a RFID reader, barcode reader, biometric scanner, and/or other input/output mechanisms. In this regard, the input/output module 508 may comprise the user interface 150. In embodiments wherein promotional system 100 is embodied as a server or database, aspects of input/output module 508 may be reduced as compared to embodiments where promotional system 100 is implemented as an end-user machine (e.g., internal user device 520) or other type of device designed for complex user interactions. In some embodiments (like other components discussed herein), input/output module 508 may even be eliminated from promotional system 100. Input/output module 508 may be in communication with the memory 504, communications module 506, and/or any other component(s), such as via a bus. Although more than one input/output module and/or other component can be included in promotional system 100, only one is shown in FIG. 5 to avoid overcomplicating the drawing (like the other components discussed herein).

Profit calculator module 110 may integrate and/or collectively provide the functionality of modules 112,114, 116 and/or 118, as described herein, to provide profit calculations of the promotion and marketing service for particular promotions or groups of promotions to internal users, as described herein and above with respect to FIG. 1 A. In some embodiments, some or all of the functionality of the modules may be performed by processor 502. For example, non-transitory computer readable storage media can be configured to store firmware, one or more application programs, and/or other software, which include instructions and other computer-readable program code portions that can be executed to control each processor (e.g., processor 502 and/or any of the modules 110, 112, 114, 116, and/or 118) of the promotional system 100 to implement various operations. As such, a series of computer-readable program code portions are embodied in one or more computer program products and can be used, with a computing device, server, and/or other programmable apparatus, to produce machine-implemented processes.

Promotional system 100 may be coupled to one or more internal user devices 520 via network 530. In this regard, network 530 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, network 530 may include a cellular telephone, an 802.11, 802.16, 802.20, and/or WiMax network. Further, the network 530 may include a public network, such as the Internet, a private network, such as an intranet, or combinations thereof, and may utilize a variety of networking protocols now available or later developed including, such as, but not limited to, TCP/IP based networking protocols.

Any number of internal user devices 520 may be implemented as a personal computer and/or other networked device, such as a cellular phone, tablet computer, mobile device, etc., that may be used to access other components of promotional system. As such, an internal user may use a internal user device 520 to view example displays provided by the profit calculator module 110 such as those provided in FIGS. 2-4. In some embodiments, input parameters defining a group of promotions may be provided from an internal user device 520 to the promotional system 100, that may be used, for example by any of the modules 110, 112, 114, 116, and/or 118.

As will be appreciated, any such computer program instructions and/or other type of code may be loaded onto a computer, processor or other programmable apparatus circuitry to produce a machine, such that the computer, processor, or other programmable circuitry that executes the code on the machine creates the means for implementing various functions, including those described herein.

It is also noted that all or some of the information presented by the example displays discussed herein can be based on data that is received, generated and/or maintained by one or more components of promotional system 100. In some embodiments, one or more external systems (such as a remote cloud computing and/or data storage system) may also be leveraged to provide at least some of the functionality discussed herein.

FIG. 6 illustrates an example process that may be performed by the promotional system 100 according to an example embodiment, for providing calculated profits. As shown by operation 602, the promotional system 100 may include means, such as communications module 506, processor 502, profit calculator module 110, and/or the like, for receiving an indication of a gross booking dollars, wherein the gross booking dollars is a hypothetical consumer cost of at least one promotion offered for sale by the promotion and marketing service. As described with respect to display 200, an internal user, such as with internal user device 520 may provide a gross booking dollar amount on which to base the profit calculations. In some example the internal user may enter an amount equal to the actual consumer cost of a promotion.

As shown by operation 606, the promotional system 100 may include means, such as processor 502, variable cost module 112, assumptions module 114, and/or the like, for dynamically determining one or more costs associated with the at least one promotion, wherein the one or more costs comprise at least a payment to the provider and a deal factory cost. As described above with respect to display 200, any number of the variable costs 216 may be dynamically determined. In some embodiments, dynamically determined costs may include receiving cost assumptions from an internal user. The assumptions may override otherwise determined or estimated costs. In some embodiments, cost may be dynamically calculated based on historical data, such as historical data associated with a category, subcategory, and/or provider. As such, actual expense data associated with past promotions may be calculated based on an average gross booking dollars, and provided as a variable cost, or dynamically determined cost.

In some examples, the one or more costs may include or be based on a provider refund rate. Refund rates may be based on historical data including past refunds issued for promotions offered for a particular provider.

In some embodiments, the one or more costs may include an estimated cost of consumer points awarded to the consumer for purchasing the promotion.

As shown by operation 610, the promotional system 100 may include means, such as processor 502, profit calculator module 110, and/or the like, for calculating the profit associated with the at least one promotion and for the promotion and marketing service based on at least the dynamically determined one or more costs. The profit may be calculated as described above with respect to area 214 of display 200. The profit may be calculated in any form of contribution profit (e.g., dollars profit per gross booking dollars), profit percent of gross booking, and/or profit margin.

As shown by operation 614, the promotional system 100 may include means, such as processor 502, input/output module 508, communications module 506, and/or the like, for causing display of the profit associated with the at least one promotion and for the promotion and marketing service. The profit may be displayed in a variety of formats, as shown in area 214 of display 200.

FIG. 7 illustrates an example process that may be performed by the promotional system 100 according to an example embodiment, for enabling dynamic grouping of promotions and associated costs and profits, such as provided in displays 300 and 400, for example. As shown by operation 702, the promotional system 100 may include means, such as processor 502, input/output module 508, communications module 506, and/or the like, for receiving an indication of a time period and an indication of at least one of a selected category, subcategory, and/or geographic location. The input parameters may be provided from an internal user device 520, such as with indicators 310, 312, 314, and/or filters 318, for example. The geographic location may be selected from a drop down menu (not shown) including a listing of cities and/or regions, for example. The geographic location may represent the area in which a provider of an offered promotion is located (e.g., the location in which the consumer may redeem an associated promotional instrument).

As shown by operation 706, the promotional system 100 may include means, such as processor 502, profit calculator module 110, and/or the like, for calculating respective profits for the promotion and marketing service during the time period and for a plurality of promotions associated with the at least one selected category, selected subcategory, or selected geographic location. In some examples, this may include accessing historical data and collecting cumulative averages and/or totals of the metrics provided on display 200 and/or 300, such as those relating to costs. In an example in which a category is selected, such as illustrated in FIG. 3, profits may be summed and/or averaged for each subcategory within the category. In an instance in which subcategory is selected, such as illustrated in FIG. 4, profits may be summed and/or averaged for individual promotions assigned to the subcategory.

As shown by operation 706, the promotional system 100 may include means, such as processor 502, input/output module 508, communications module 506, and/or the like, for causing display of the respective profits, such as provided in displays 300 and 400.

With an interface provided by the profit calculator module 110, internal users may analyze data relating to promotions, costs, and profits. Internal users may therefore efficiently identify patterns in promotions returning high profits to the promotion and marketing service and base key business decisions on such patterns. For example, providers found to offer promotions leading to high profits for the promotion and marketing service may be targeted as a repeat business partner. Categories and/or subcategories of promotions associated with high profits for the promotion and marketing service may help internal users identify additional providers capable of offering promotions in the same categories and/or subcategories.

The profit calculator module 110 may additionally or alternatively fully utilize general business expense data, such as that captured by the expense database 108 that may otherwise not be considered when quickly viewing or calculating profits associated with particular promotions and/or groups of promotions. The profit calculator module 110 may therefore provide a valuable resource to internal users and any decision makers for the promotion and marketing service. In some examples, as the promotion and marketing system grows, various business units may offer promotions and special marketing incentives that may impact the cost and profit modules described herein. According to embodiments provided herein, such information may be provided to the system 100 such that the most recent data is reelected in the profit and cost calculations. Communication between business units a regarding such volatile costs may therefore not be required to obtain the most up to date and accurate calculations. As business expands, and the amount of interactions with the EDW 120 grows accordingly, the calculation produced by the profit calculation module 110, as described herein, may continue to provide accurate information to the promotion and marketing service.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus, such as processor 502, modules 110, 112, 114, 116, and/or 118 to produce a machine, such that the computer program product includes the instructions which execute on the computer or other programmable data processing apparatus create a means for implementing the functions specified in the flowchart block or blocks.

These computer program instructions may also be stored in a computer-readable storage medium (e.g., memory 504) that can direct a computer or other programmable data processing apparatus to function in a particular manner, such that the instructions stored in the computer-readable storage medium produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for calculating profit for a promotion and marketing service, the method comprising:
receiving an indication of a gross booking dollars, wherein the gross booking dollars is a hypothetical consumer cost of at least one promotion offered for sale by the promotion and marketing service, and wherein the at least one promotion is redeemable by the consumer at a provider;
with a processor, dynamically determining one or more costs associated with the at least one promotion, wherein the one or more costs comprise at least a payment to the provider and a deal factory cost;
calculating the profit associated with the at least one promotion and for the promotion and marketing service based on at least the dynamically determined one or more costs; and
causing display of the profit associated with the at least one promotion and for the promotion and marketing service.

2. The method of claim 1, further comprising:
receiving cost assumptions from an internal user, wherein the profit for the promotion and marketing service is further based on at least the cost assumptions from the internal user.

3. The method of claim 1, wherein the one or more costs are based on historical data associated with a promotion category.

4. The method of claim 1, wherein the one or more costs are based on historical data associated with the provider.

5. The method of claim 1, further comprising:
receiving an indication of a time period and a selected category;
calculating respective profits for the promotion and marketing service for a plurality of subcategories associated with the selected category; and
causing display of the respective profits for each of the plurality of subcategories.

6. The method of claim 1, further comprising:
receiving an indication of a time period, and an indication of at least one of a selected category, selected subcategory, or geographic location;
calculating respective profits for the promotion and marketing service during the period of time and for a plurality of respective promotions associated with the at least one selected category, selected subcategory, or selected geographic location; and
causing display of the respective profits for each of the plurality of promotions.

7. The method of claim 1, wherein the one or more costs comprise an estimated amount of net refunds per promotion based on a provider refund rate.

8. The method of claim 1, wherein the one or more costs comprise an estimated cost of consumer points awarded to the consumer for purchasing the promotion.

9. The method of claim 1, further comprising:
providing an interface to the internal user;
receiving a request via the interface to display a plurality of promotions and associated profits;
ranking the plurality of promotions according to the request; and
causing display of the plurality of promotions and associated profits in ranked order.

10. A computer program product for calculating profit for a promotion and marketing service, the computer program product comprising at least one non-transitory computer-readable medium having computer-readable program instructions stored therein, the computer-readable program instructions comprising instructions, which when performed by an apparatus, are configured to cause the apparatus to perform at least:
receiving an indication of a gross booking dollars, wherein the gross booking dollars is a hypothetical consumer cost of at least one promotion offered for sale by the promotion and marketing service, and wherein the at least one promotion is redeemable by the consumer at a provider;
dynamically determining one or more costs associated with the at least one promotion, wherein the one or more costs comprise at least a payment to the provider and a deal factory cost;
calculating the profit associated with the at least one promotion and for the promotion and marketing service based on at least the dynamically determined one or more costs; and
causing display of the profit associated with the at least one promotion and for the promotion and marketing service.

11. The computer program product of claim 10, wherein the computer-readable program instructions further comprise instructions, which when performed by an apparatus, are configured to cause the apparatus to perform at least:
receiving cost assumptions from an internal user, wherein the profit for the promotion and marketing service is further based on at least the cost assumptions from the internal user.

12. The computer program product of claim 10, wherein the one or more costs are based on historical data associated with a promotion category.

13. The computer program product of claim 10, wherein the one or more costs are based on historical data associated with the provider.

14. The computer program product of claim 10, wherein the computer-readable program instructions further comprise instructions, which when performed by an apparatus, are configured to cause the apparatus to perform at least:
receiving an indication of a time period and a selected category;
calculating respective profits for the promotion and marketing service for a plurality of subcategories associated with the selected category; and
causing display of the respective profits for each of the plurality of subcategories.

15. The computer program product of claim 10, wherein the computer-readable program instructions further comprise instructions, which when performed by an apparatus, are configured to cause the apparatus to perform at least:
receiving an indication of a time period, and an indication of at least one of a selected category, selected subcategory, or geographic location;
calculating respective profits for the promotion and marketing service during the period of time and for a plurality of respective promotions associated with the at least one selected category selected subcategory, or selected geographic location; and
causing display of the respective profits for each of the plurality of promotions.

16. The computer program product of claim 10, wherein the one or more costs comprise an estimated amount of net refunds per promotion based on a provider refund rate.

17. The computer program product of claim 10, wherein the one or more costs comprise an estimated cost of consumer points awarded to the consumer for purchasing the promotion.

18. The computer program product of claim 10, wherein the computer-readable program instructions further comprise instructions, which when performed by an apparatus, are configured to cause the apparatus to perform at least:
providing an interface to the internal user;
receiving a request via the interface to display a plurality of promotions and associated profits;
ranking the plurality of promotions according to the request; and
causing display of the plurality of promotions and associated profits in ranked order.

19. An apparatus for calculating profit for a promotion and marketing service, the apparatus comprising processing circuitry configured to cause the apparatus to perform at least:
receiving an indication of a gross booking dollars, wherein the gross booking dollars is a hypothetical consumer cost of at least one promotion offered for sale by the promotion and marketing service, and wherein the at least one promotion is redeemable by the consumer at a provider;
dynamically determining one or more costs associated with the at least one promotion, wherein the one or more costs comprise at least a payment to the provider and a deal factory cost;
calculating the profit associated with the at least one promotion and for the promotion and marketing service based on at least the dynamically determined one or more costs; and
causing display of the profit associated with the at least one promotion and for the promotion and marketing service.

20. The apparatus of claim 19, wherein the processing circuitry is further configured to cause the apparatus to perform at least:
receiving cost assumptions from an internal user, wherein the profit for the promotion and marketing service is further based on at least the cost assumptions from the internal user.

21. The apparatus of claim 19, wherein the one or more costs are based on historical data associated with a promotion category.

22. The apparatus of claim 19, wherein the one or more costs are based on historical data associated with the provider.

23. The apparatus of claim 19, wherein the processing circuitry is further configured to cause the apparatus to perform at least:
receiving an indication of a time period and a selected category;
calculating respective profits for the promotion and marketing service for a plurality of subcategories associated with the selected category; and
causing display of the respective profits for each of the plurality of subcategories.

24. The apparatus of claim 19, wherein the processing circuitry is further configured to cause the apparatus to perform at least:
receiving an indication of a time period, and an indication of at least one of a selected category, selected subcategory, or geographic location;
calculating respective profits for the promotion and marketing service during the period of time and for a plurality of respective promotions associated with the at least one selected category, selected subcategory, or selected geographic location; and
causing display of the respective profits for each of the plurality of promotions.

25. The apparatus of claim 19, wherein the one or more costs comprise an estimated amount of net refunds per promotion based on a provider refund rate.

26. The apparatus of claim 19, wherein the one or more costs comprise an estimated cost of consumer points awarded to the consumer for purchasing the promotion.

27. The apparatus of claim 19, wherein the processing circuitry is further configured to cause the apparatus to perform at least:
providing an interface to the internal user;
receiving a request via the interface to display a plurality of promotions and associated profits;
ranking the plurality of promotions according to the request; and
causing display of the plurality of promotions and associated profits in ranked order.
